(19) United States
(12) Patent Application Publication
(10) Pub. No.: US 2003/0000798 A1
(43) Pub. Date: Jan. 2, 2003

(54) Universal escalator control system

(76) Inventors: Todd Y. Williams, Pinckney, MI (US); Timothy Z. Peters, Grosse Pointe Park, MI (US)

Correspondence Address: Jennifer H. Hammond, Esq., SONNENSCHEIN NATH & ROSENTHAL, Sears Tower, Wacker Drive Station, P.O. Box 061080, Chicago, IL, 60606-1080, US

(21) Appl. No.: 10/159,863

(22) Filed: May 31, 2002

Related U.S. Application Data
(60) Provisional application No. 60/295,362, filed on May 31, 2001.

(51) Int. Cl. B66B 31/00

(52) U.S. Cl. 198/321; 187/292; 187/391; 318/806; 340/679

(57) ABSTRACT

The present invention provides a control system designed for use in either new or existing escalators or moving walkways. The control system is comprised of a main controller and a variable frequency drive. The main controller is attached to the variable frequency drive which controls the speed of the motor based upon various environmental changes, such as passenger load and safety conditions. The control system of the present invention utilizes motions sensors, time relay switches, proximity switches and other electromechanical detectors as intelligence to detect faults and to control and vary the speed of the motor through the variable frequency drive.

This application claims priority of U.S. provisional application Serial No. 60/295,362 filed on May 31, 2001, which is incorporated herein by reference.

### BACKGROUND OF THE INVENTION

1. Field of the Invention

The present invention generally relates to a system for controlling and monitoring the motion, operation, performance, condition and safety of a moving walkway or escalator. In particular, the control system is designed to be utilized with either existing or new escalators and moving walkways.

2. Description of the Related Art

Currently, sophisticated escalator or moving walkway control systems are microprocessor based control systems that are built by original equipment manufacturers (“OEMs”). Typically, these microprocessor based control systems are highly proprietary to each OEM. As a result, the microprocessor based systems are not generally designed to be retrofitted to existing systems. Thus, existing escalators must generally be completely overhauled or replaced for the installation of a microprocessor based control system. Furthermore, all purchases of an OEM control system generally includes a service contract since no other company besides the OEM is typically able to maintain the highly proprietary system, including the purchaser.

To date, systems which are easily maintained have not been as sophisticated as the microprocessor based control systems. Although these microprocessor based control systems are often undesirable from the service and maintenance standpoint, microprocessor based systems provide added functionality over the previous systems.

A need therefore exists for a sophisticated escalator control system that does not utilize a highly proprietary microprocessor based control system, but utilizes equipment that is compact and that is easy to install, maintain, repair, replace and upgrade and that can be retrofitted to existing systems, all without the assistance of the OEM.

### SUMMARY OF THE INVENTION

The present invention provides a control system designed for use in either new or existing escalators or moving walkways. The control system is comprised of two major components: a main controller and a variable frequency drive. The main controller is attached to the variable frequency drive which controls the speed of the motor based upon various environmental changes, such as passenger load and safety conditions. Unlike the microprocessor based systems, the control system of the present invention utilizes motions sensors, time relay switches, proximity switches and other electromechanical detectors as intelligence to detect faults and to control the application and timing of the brake and to control and vary the speed of the motor via the variable frequency drive.

When used in connection with existing systems, the main controller may utilize existing field components, such as field wiring, safety devices, emergency stops and the lighting system, as originally installed. Major and minor faults are monitored by emergency stop relays. Escalator speed signals are monitored by individual speed relays. Circuitry for starting and stopping the escalator by the means of push buttons are located, at minimum, at the upper and lower entrances and/or exits to the escalator. All circuits are designed in a fail-safe mode. Thus, the absence of power or a signal, due to the detection of a fault, among other things, will cause the escalator to stop.

The motor for the escalator and moving walkway is controlled by a variable frequency controller. The controller receives operating parameters (run signal) from the main controller. Starting and stopping characteristics are programmed into the main controller, which allow for a pre-programmed acceleration and deceleration rate, along with a speed rate.

### BRIEF DESCRIPTION OF THE DRAWINGS

A more complete appreciation of the invention and many of the advantages thereof will be readily obtained as the same becomes better understood by references to the detailed description when considered in connection with the accompanying drawings, wherein:

FIG. 1 is a block diagram of one embodiment of the escalator control system of the present invention;

FIG. 2 is a diagram illustrating the electrical schematics of the main controller and variable frequency drive;

FIG. 3 is a diagram illustrating the electrical schematics of the main controller and the lighting system;

FIG. 4 is a circuit diagram illustrating the motion control system, including proximity sensors for detecting the speed of the handrail and escalator stairs;

FIG. 5 is a diagram illustrating the electrical schematics of the stop button, the main controller and the horn;

FIG. 6 is a partial hardware electrical schematic of the main controller;

FIG. 7 is a continuation from FIG. 6 of the hardware electrical schematic of the main controller;

FIG. 8 is a continuation from FIG. 7 of the hardware electrical schematic of the main controller;

FIG. 9 is a partial diagram of the interlocks to the upper fault box;

FIG. 10 is a continuation from FIG. 9 of the diagram of the interlocks to the upper fault box;

FIG. 11 is a partial diagram of the interlocks to the lower fault box;

FIG. 12 is a continuation from FIG. 11 of the diagram of the interlocks to the lower fault box; and

FIG. 13 is a block diagram of the present invention illustrating its use in connection with an Ethernet or Internet type monitoring system.

### DETAILED DESCRIPTION OF THE PREFERRED EMBODIMENT

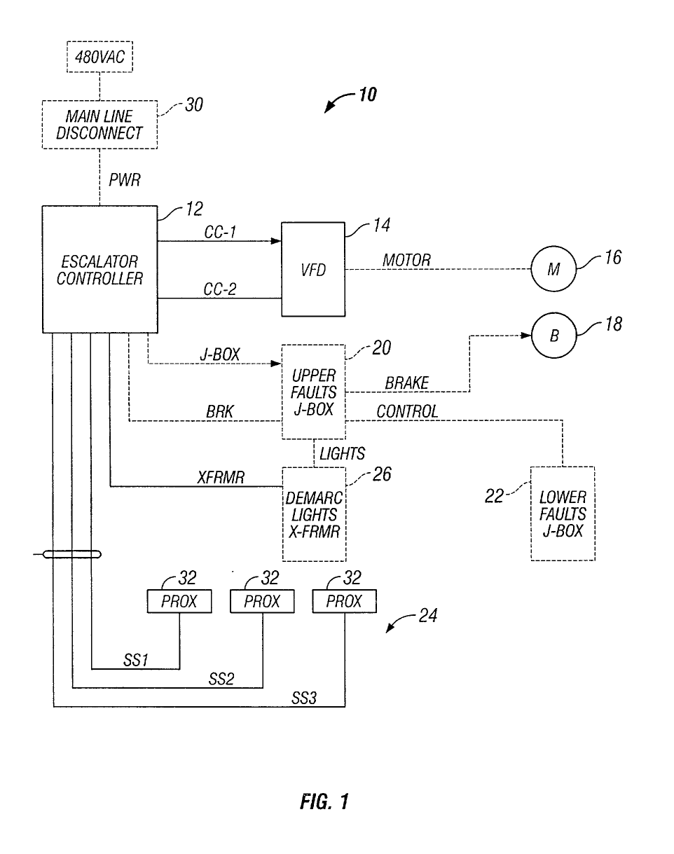

Turning now to the detailed drawings, FIG. 1 is a block diagram of one embodiment of the escalator control system 10 of the present invention. In this embodiment, the escalator control system 10 is comprised of a main controller 12, an upper fault box 20, a lower fault box 22, a variable frequency drive 14, a motor 16, a brake 18, a lighting system 26 and a motion control system 24 comprised of, among other things, several proximity switches 32.

As seen in FIG. 1, the main controller 12 is powered via 480 V/AC through a main line disconnect 30. The main controller 12 connects directly to the variable frequency drive 14, the upper fault box 20 and the lighting system 24, as well as to a motion control system 24 for monitoring the movement and speed of the handrails and escalator stairs. The variable frequency drive 14 is used to control the speed of the motor 16 and, as shown in FIG. 1, may be connected to the upper fault box 20, which is then connected directly to the motor 16. Alternatively, the variable frequency drive 14 may be connected directly to the motor 16.

Further, circuitry extends from the lower and upper fault boxes 20 and 22 for push buttons and switches (not shown) used to stop the escalator in the event of an emergency or to change the direction of the escalator. These buttons and switches are generally positioned near the handrails of the escalator. One set of buttons and switches extend from the upper fault box 20 and are connected to the upper hand rail, while another identical set of buttons and switches extend from the lower fault box 22 and are connected to the lower hand rail of the escalator.

While FIG. 1 illustrates the escalator control system 10 having a upper fault box 20 and a lower fault box 22, the upper and lower fault boxes 20 and 22 are not essential to the escalator control system 10. In its simplest form, the escalator control system 10 may only include the main controller 12 connected directly to a variable frequency drive 14, a motor 16, a brake 18 and a lighting system. The main controller would also include a motion detecting system 24 and a fault detecting system that communicates directly with the main controller 12 rather than via a junction box, i.e., upper and lower fault boxes 20 and 22. Thus, the intermediate upper and lower fault boxes 20 and 22 may be eliminated. By removing the upper and lower fault boxes 20 and 22, certain additional functionalities may, however, be lost.

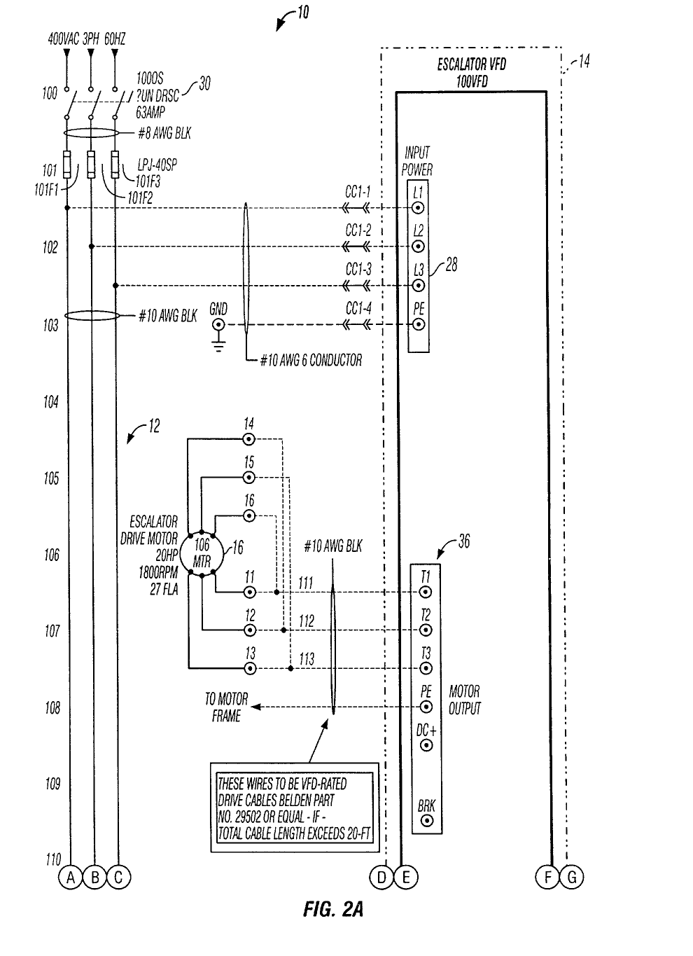

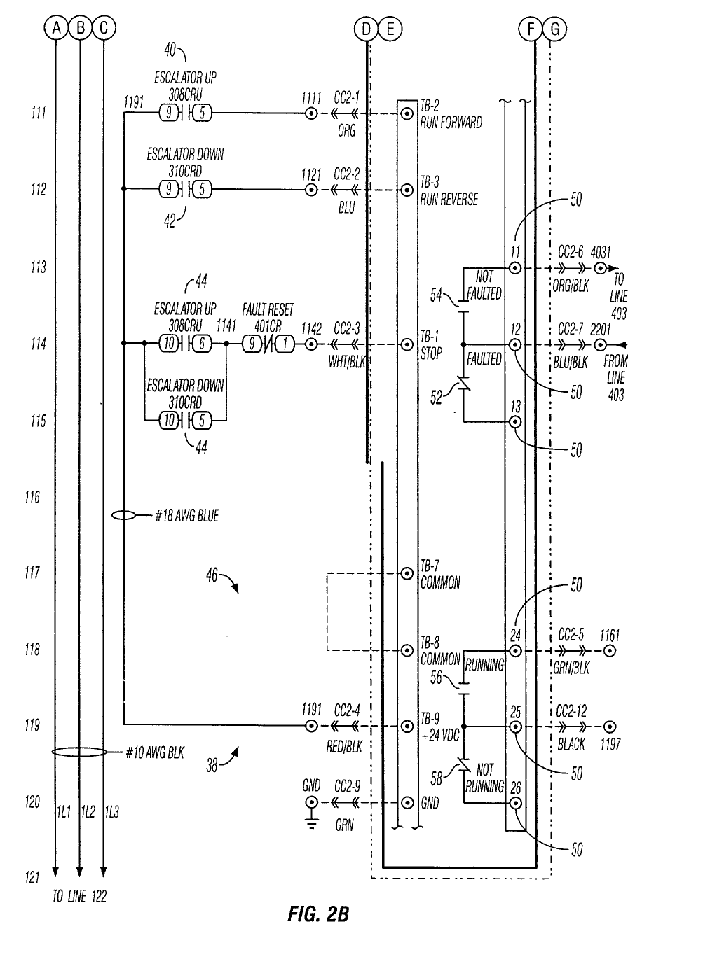

FIG. 2 is a diagram illustrating the electrical schematics of the main controller 12 and the variable frequency drive 14. In this diagram, as well as in the diagrams contained in FIGS. 1-12, all solid lines represent equipment and/or circuitry located in the main controller 12 and all dashed lines, both evenly and unevenly spaced, represent equipment or devices which are field mounted outside of the main controller 12.

As illustrated, 480 V/AC is supplied to the main controller 12, which then powers the variable frequency drive 14 via a three-phase power input 28. Once powered, the variable frequency drive 14 is able to output alternating current to the motor 16. In the illustrated embodiment, current is output to the motor 16 via three power output wires 29.

Also illustrated on FIG. 2 is one embodiment of a start/stop control circuit 38, which controls the direction of the escalator stairs and starts and stops the escalator via maintained contacts 40, 42 and 44. The start/stop control circuit 38 illustrated in this embodiment is a three-wire start/stop control scheme 46 using one maintained contact 40 to run the escalator up, another maintained contact 42 to run the escalator down, as well as start and stop contacts 44. While this diagram illustrates a three-wire start/stop control scheme 46, other control schemes, such as traditional and alternate two-wire control schemes, may also be utilized depending upon the needs of the system 10.

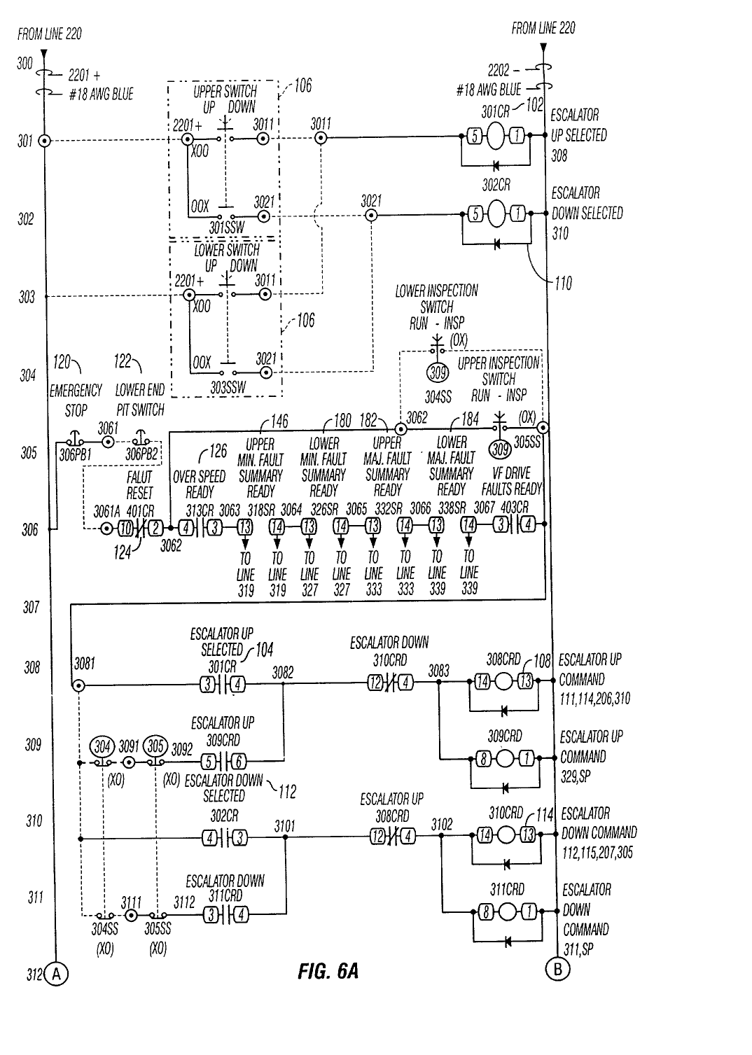

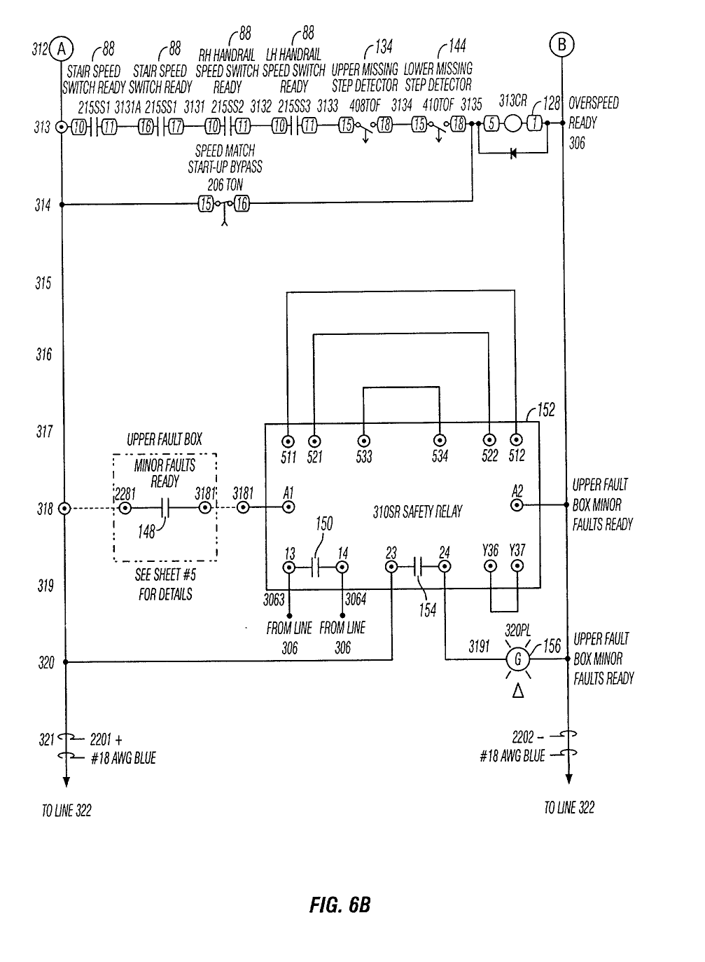

Terminals 50 are also included in the variable frequency drive 12 for determining whether the variable frequency drive is faulted or not faulted and running or not running via maintained contacts 52, 54, 56 and 58, respectively, and for communicating this information the main controller 12, as illustrated further in FIGS. 6, 7 and 8 and as described below.

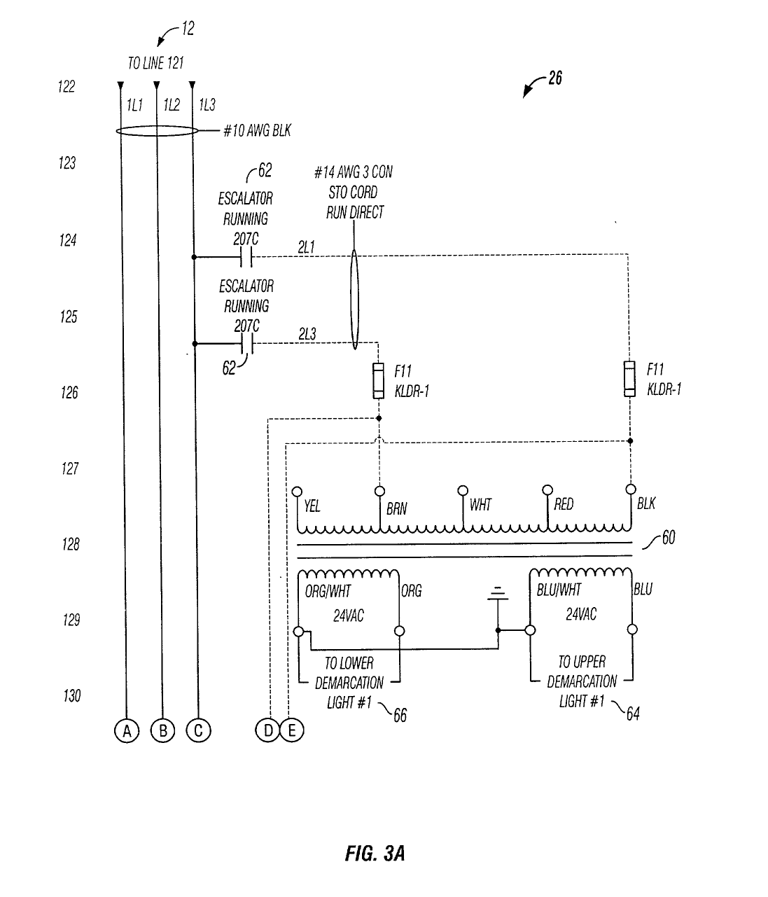

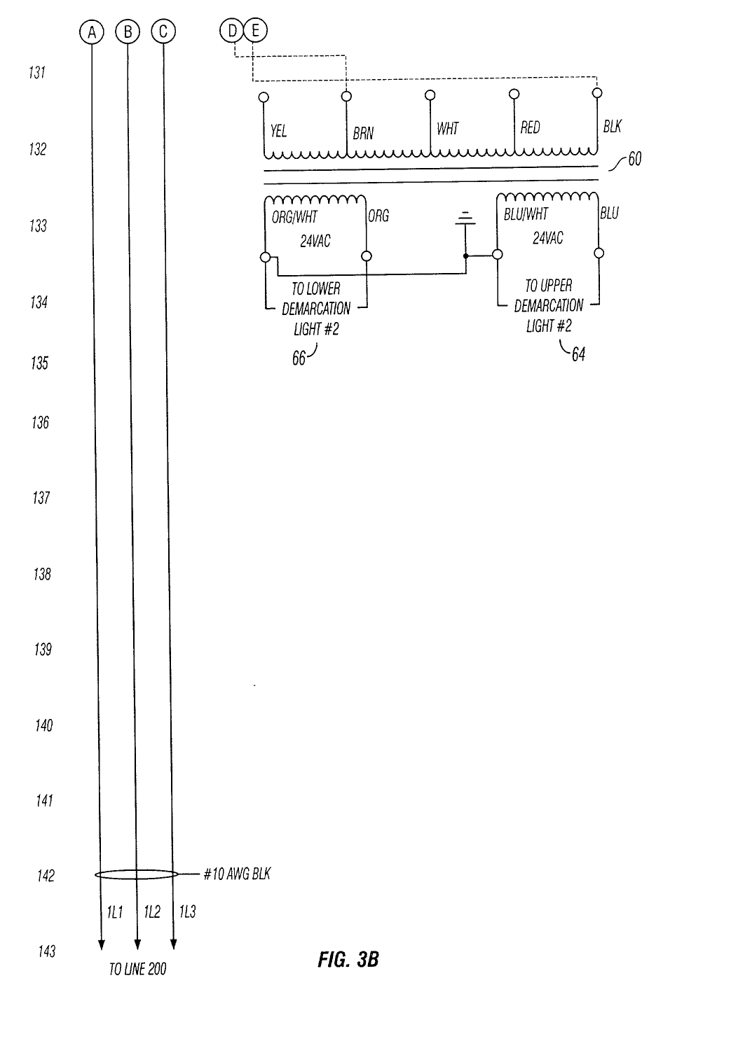

FIG. 3 is a circuit diagram illustrating the connection between the main controller 12 and the lighting system 26. When the escalator is running, the circuit to the lighting system 26 is closed via maintained contacts 62, sending 480 V/AC to the lighting system 26, which is then converted to 24 V/AC via converters 60 to power the upper demarcation lights 64 and lower demarcation lights 66.

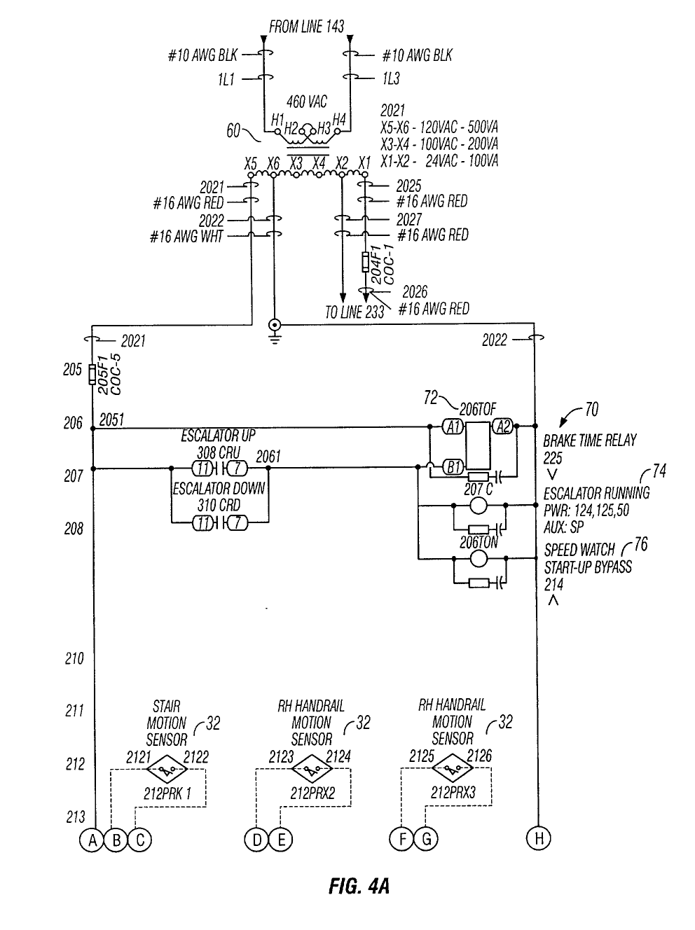

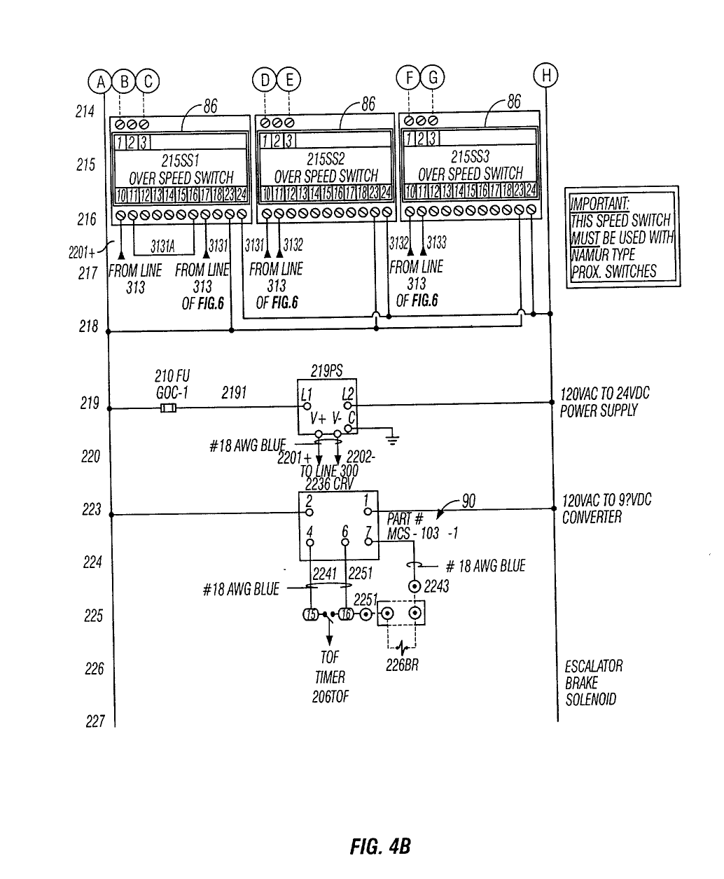

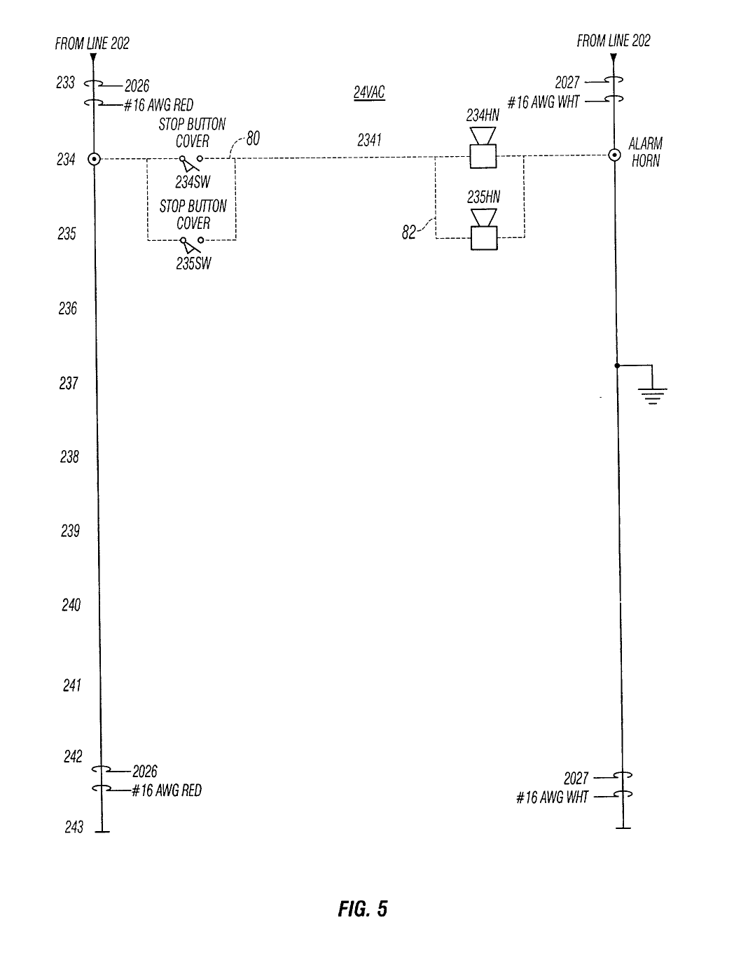

FIG. 4 illustrates the motion control system 24 of the present invention. As illustrated in FIG. 4, the 480 V/AC is converted via a converter 60 into both 24 V/AC and 120 V/AC. The 120 V/AC circuit is shown in FIG. 4, whereas the 24 V/DC circuit is illustrated in FIG. 5. Illustrated in this diagram is a relay loop 70 containing a brake time relay 72, which communicates with a brake solenoid 90. The time relay 72 and the break solenoid 90 control the timing of the release and/or application of the brake relative to the speed of the escalator as detected by the escalator running relay 74 and as compared to speed match relay 76. The relay loop 70, in conjunction with the brake solenoid 90, give the system the ability to stop the brake 18 outside the normal stopping time of the variable frequency drive 14. For example, the relay loop 70 may give the system 10 the ability to stop the brake 18 approximately one second outside of the variable frequency drive 14.

Also illustrated in FIG. 4 is the schematics for the proximity switches 32 for detecting the motion of the escalator stairs and handrails. These proximity switches 32 are each connected to over speed switches 86, which are connected to maintained contacts and switches 88 for faults relating the speed of the escalators and handrails (as shown in FIG. 6). If the motion sensors 32 detect that the hand rails and/or stairs are moving at an undesirable or unsafe rate, the switches and/or contacts 88 are opened, thereby indicating an over speed fault in the system 10.

FIG. 5 illustrates the circuitry connected to a stop button cover switch 80 and a horn 82. This circuit extends from line 202 in FIG. 4. Although not shown, the stop button typically has a cover over the button that must be lifted in order to press the stop button. When the cover of the stop button is opened, the circuit is closed, which sounds an alarm or horn 82 to warn that the stop button may be pressed and the escalator may stop.

FIG. 6 illustrates further electrical schematics for the main controller 12, and in particular, the electrical schematics for manually selecting the direction of the escalator via switches 106 and for verifying that all faults are ready before allowing the escalator to move. When the manual switch 106 is selected to move the escalator up, the relay 102 for the escalator up closes the contact 104 in the controller 12, which is in series with all the fault indicators. Thus, if no faults are detected, the circuit is closed and a second relay signal 108 closes all remaining maintained contacts related to the movement of the upward direction, which includes the start/stop control circuit 38 that starts the motor 16 via the variable frequency drive 18, as illustrated by FIG. 1.

Similarly, when the escalator switch 106 is selected to move the escalator down, the corresponding relay 110 closes the maintained contact 112 in series with the fault indicators. Again, if no faults are detected, a second corresponding relay signal 114 closes all the maintained contacts related to the movement of the escalator downward, including the start/stop control circuit 38 that starts the motor 16 via the variable frequency drive 18, as illustrated by FIG. 1.

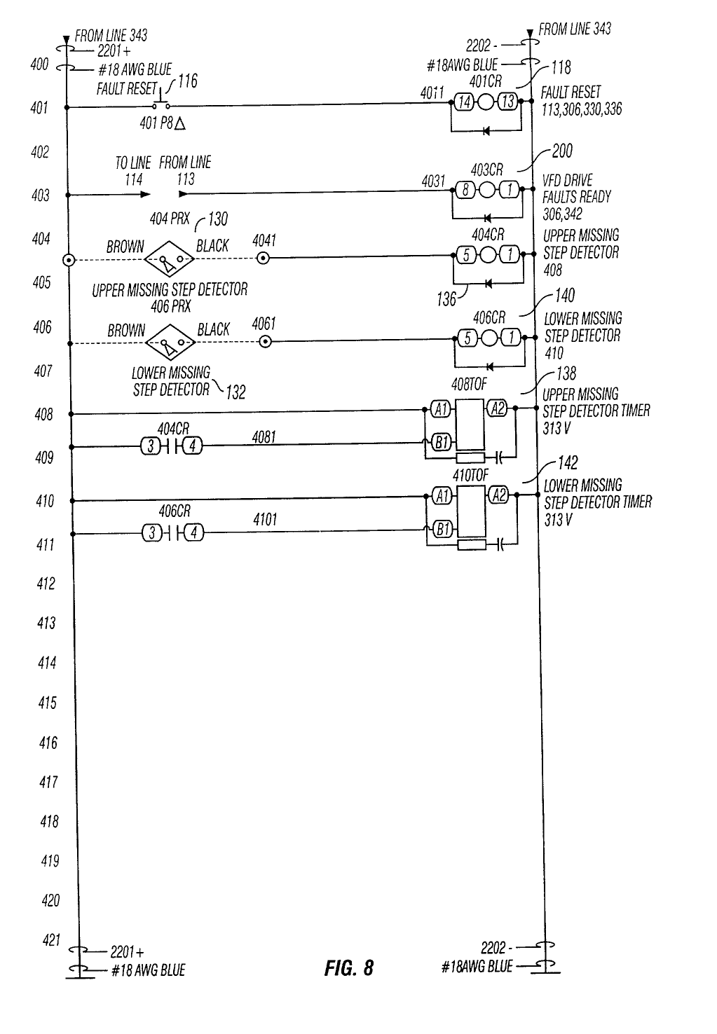

As seen in FIG. 6, all of the fault ready switches are in series with the maintained contacts 104 and 112 that are closed based upon the escalator directional switches 106. Thus, the circuit must be closed, including all the circuitry regarding the faults, to complete the circuit and to allow for the operation of the escalator. The first fault illustrated in series, in line 306, is the emergency stop button 120, followed by the lower end pit switch 122 and a fault reset 124. The fault reset button 116 is represented in FIG. 8. When the fault reset button 116 is pressed, a fault reset relay 118 resets the fault reset 124 shown in line 306 to help complete the circuit.

The next contact relating to a fault is the over speed ready summary, which is represented by the maintained contact 126 and which remains closed so long as the system does not detect any faults related to the speed and/or motion of the stairs or handrails. If, however, a fault is detected, the over speed relay 128 opens the contact 126.

As previously discussed, the over speed relay faults are detected by the proximity switches 32 shown in FIG. 4, which opens the contacts and switches represented in line 313 of the schematic, if a fault is detected. In addition to the motion faults detected by the proximity switches 32, two other faults are monitored via the circuitry of line 313, which control the over speed relay. These faults are the lower and upper missing step detectors.

Proximity switches 130 and 132, shown in line 404 and 408 of FIG. 8, detect whether a step is missing. So long as the upper sensor does not detect a missing step, the upper missing step detector switch 134 (FIG. 6) remains closed. If, however, an upper step is detected missing by the proximity switch 130, an upper missing step detector relay 136 triggers a upper missing step detector timer 138, which opens the switch 134 and causes the relay 128 to open the over speed ready summary maintained contact 126. When opened, the escalator is either prevented from starting or forced to stop.

Similarly, as shown in FIG. 8, the proximity switch 132 monitors the lower stairs to detect whether or not a stair is missing. If a missing stair is detected, the switch 132 triggers a relay 140 that communicates with a lower step detector timer 142, which will open the lower missing step detector switch 144 (shown in line 313 of FIG. 6). Once the lower missing step detector switch 144 is open, the over speed relay 128 opens the over speed ready summary maintained contact 126 and the system is shut down or prevented from starting.

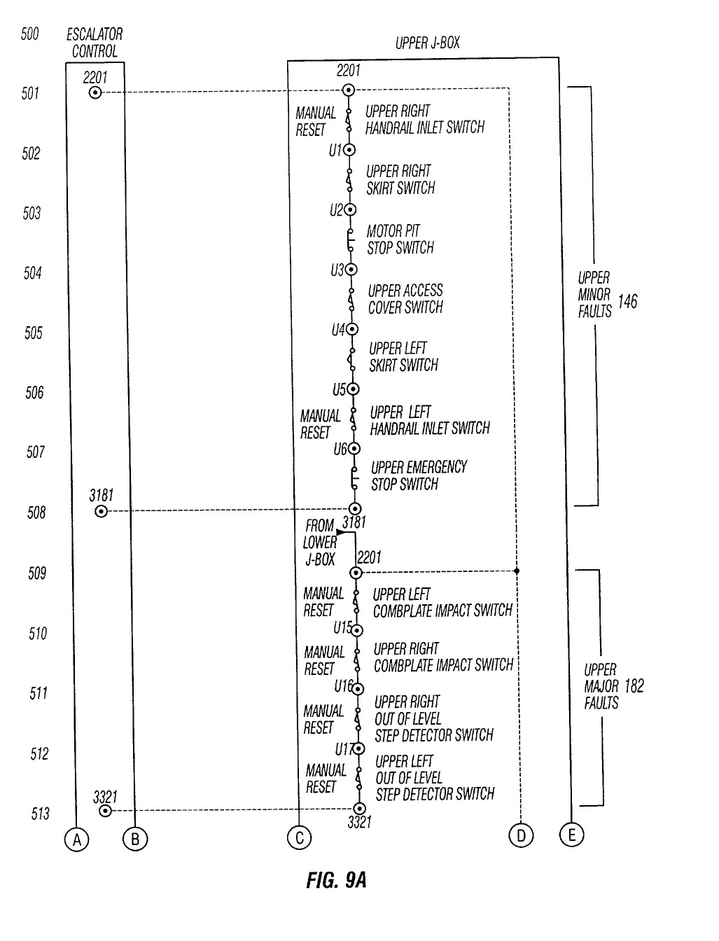

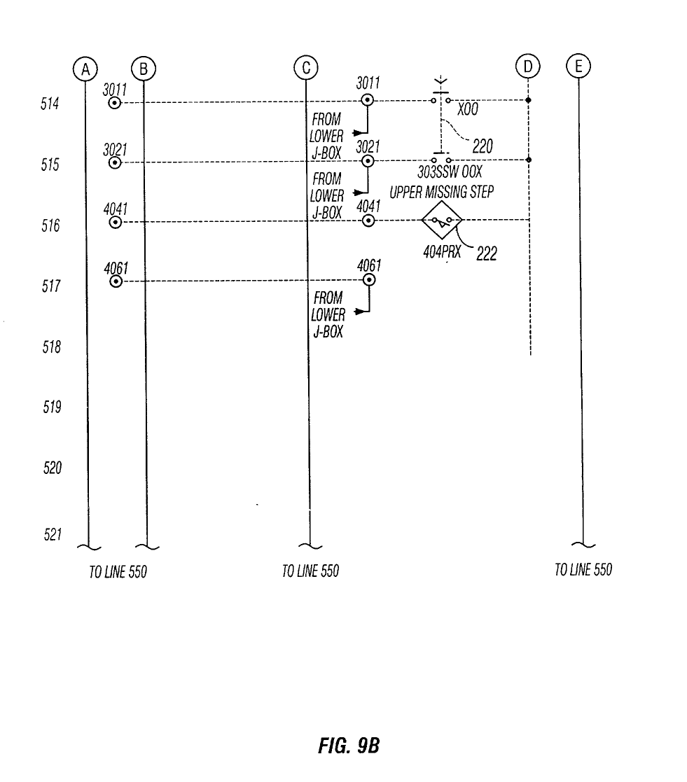

Summaries of the upper and lower minor and major faults circuits are represented by the series of fault summary in line 306 of FIG. 6. This illustrates that all of the circuits relating to the upper and lower minor and major faults are in series and must be closed for the escalator to run under normal operating conditions. The first in the series is the upper minor faults 146, which is represented by line 318 of FIG. 6. As illustrated by line 318, a maintained contact 148 will remain closed if no minor faults are detected by the upper fault box 20 (See FIGS. 9 &10). So long as the maintained contact 148 remains closed, the maintained contact 150 in the safety relay 152 for the upper minor faults 146 also remains closed, which completes the circuit for the upper minor faults 146 in line 306. One additional maintained contact 154 is also provided to illuminate a light 156 on the main controller 12, which indicates that there are no upper minor faults.

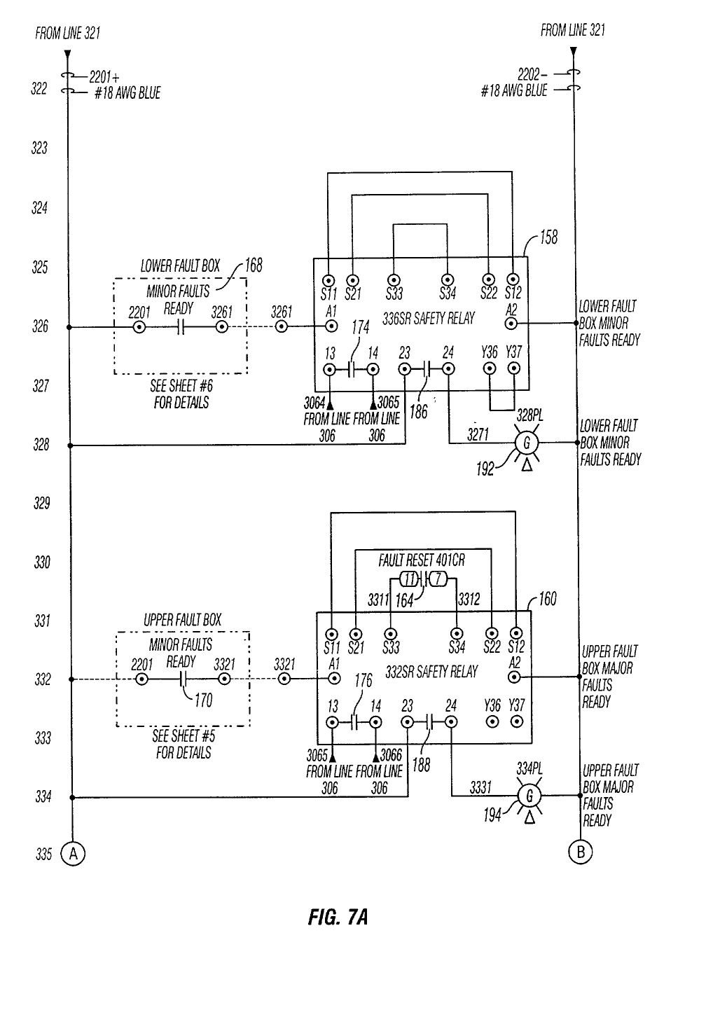

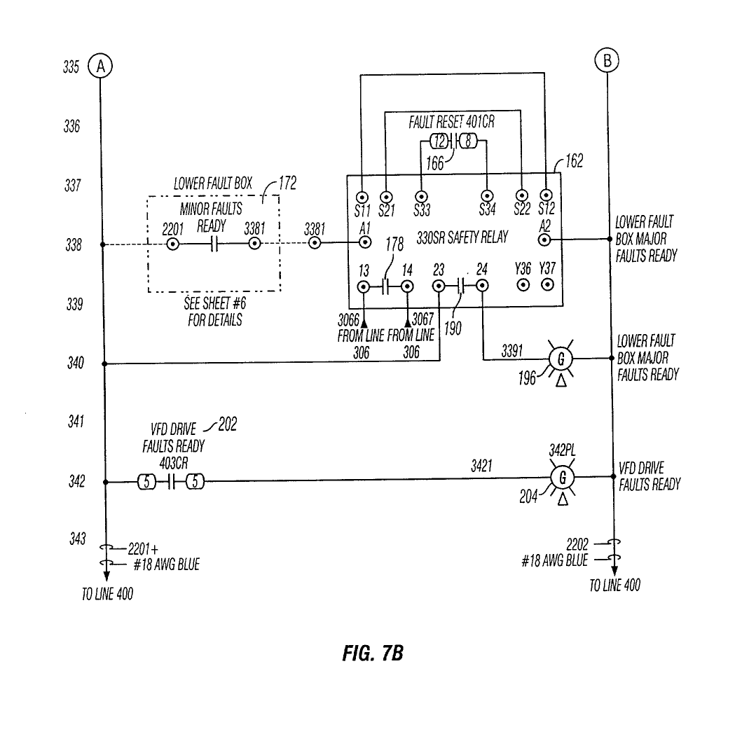

FIG. 7 shows the safety relays for lower minor faults 158, the upper major faults 160 and the lower major faults 162. All safety relays 152, 158, 160 and 162 operate in the same manner, except that the safety relays for the upper and lower major faults 160 and 162 include fault resets 164 and 166, respectively. Thus, when no faults are indicated from either the upper or lower fault boxes, all the maintained contacts 148, 168, 170 and 172 remain closed, which in turn keeps the maintained contacts 150, 174, 176 and 178 in the safety relays 152, 158, 160 and 162 closed. This creates a closed circuit in line 306 of FIG. 6 for the upper minor fault summary 146, the lower minor fault summary 180, the upper major fault summary 182 and lower major fault summary 184. Moreover, when no minor faults are detected for the lower fault box 22, the maintained contacts 186 and 190 in the safety relays 158 and 162 remain closed, each illuminating a light 192 and 196 on the main controller 12. One light 192 indicates no minor faults detected by the lower fault box 22 while the other light 196 indicates that there are no major faults detected by the lower fault box 22.

The last fault ready summary in line 306 is the fault ready maintained contact for the variable speed drive 198. Referring again to FIG. 8, if there is a fault in the variable frequency drive 14 (as determined by the circuit in FIG. 1), a relay 200 for the variable frequency drive will open the maintained contact 198 shown in line 306, preventing the escalator from starting or from continuing to run. Similarly, so long as no fault is detected in the variable frequency drive 14, the maintained contact 202 at line 342 of FIG. 7 will remain closed, thereby illuminating a variable frequency drive fault ready light 204.

Finally, to help troubleshoot the system, as illustrated in lines 304 and 305 of FIG. 8, upper and lower inspection switches 206 and 208 are provided to complete the circuit despite any over speed faults, upper and lower minor and major faults and/or a fault in the variable frequency drive 14.

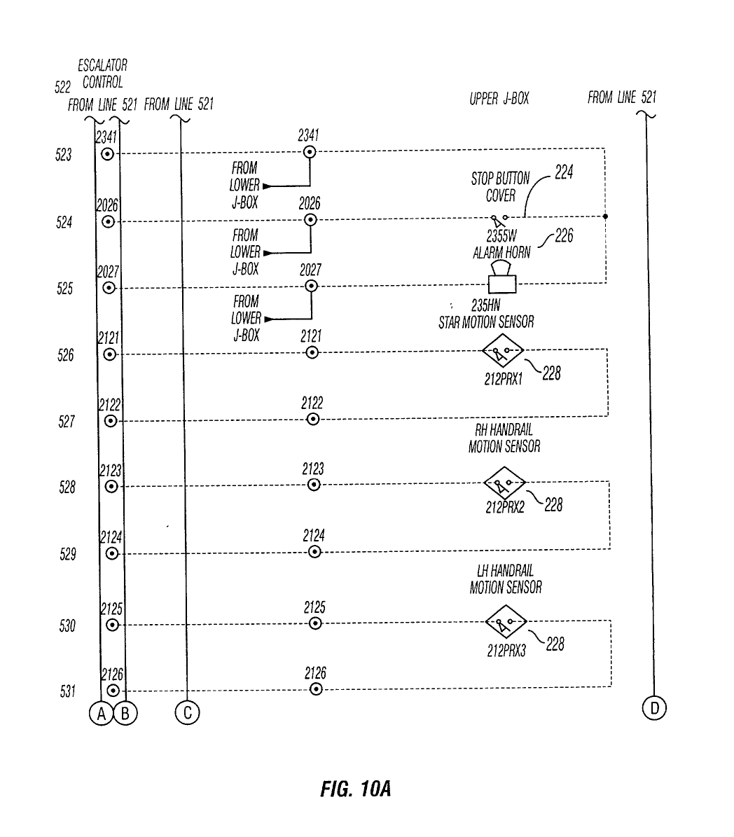

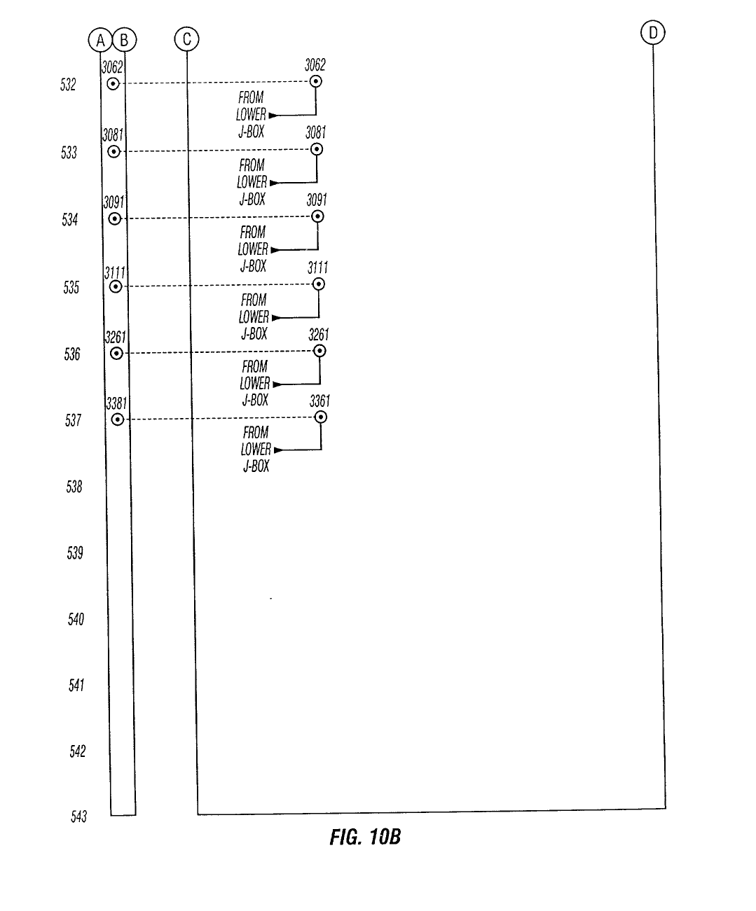

FIGS. 9 and 10 are a schematic of the upper fault box 22 that illustrates the interlocking of the fault detectors and auxiliary switches and devices with the upper fault box 22. As illustrated by FIG. 9, the switches for the upper minor faults 146 are all positioned in series, which as illustrated in FIG. 8, maintain the contacts for the upper minor fault box 148, which then communicates with the safety relay for the upper minor fault box 152.

As seen in FIG. 9, common minor upper faults include those faults triggered by problems relating to the upper right handrail, upper right skirt switch, upper access cover switch, upper left skirt switch, and upper left handrail. Upper minor faults are also triggered by the engagement of the upper emergency stop switch and the motor pit stop switch.

Similarly, switches for upper major faults 182 are also positioned in series, which maintain the contact 170 that communicates with the safety relay for the upper major faults 160. These switches are for faults relating to the upper left combplate, upper right combplate, upper right out of level step detector, and upper left out of level step detector. All of the switches that relate to any major fault, including the minor faults for the handrail, must be manually reset for the system to start or resume after the fault is detected. This is indicated in FIG. 9 by the manual reset notations near the relevant switches for those particular faults.

The upper fault box also communicates with an upper key switch 220 and an upper missing step proximity sensor, as shown in FIG. 9, and a stop cover button 224, a horn 226 and motion sensor proximity switches 228, as shown in FIG. 10.

Similar to FIGS. 9 and 10, FIGS. 11 and 12 are schematics of the lower fault box that illustrates the interlocking of the fault detectors and auxiliary switches and devices to the lower fault box. As illustrated by FIG. 10, the switches for the lower minor faults 180 are all positioned in series, which as illustrated in FIG. 8, maintains the maintained contact 168 for the lower minor fault box, which communicates with the safety relay 158 for the lower minor fault box.

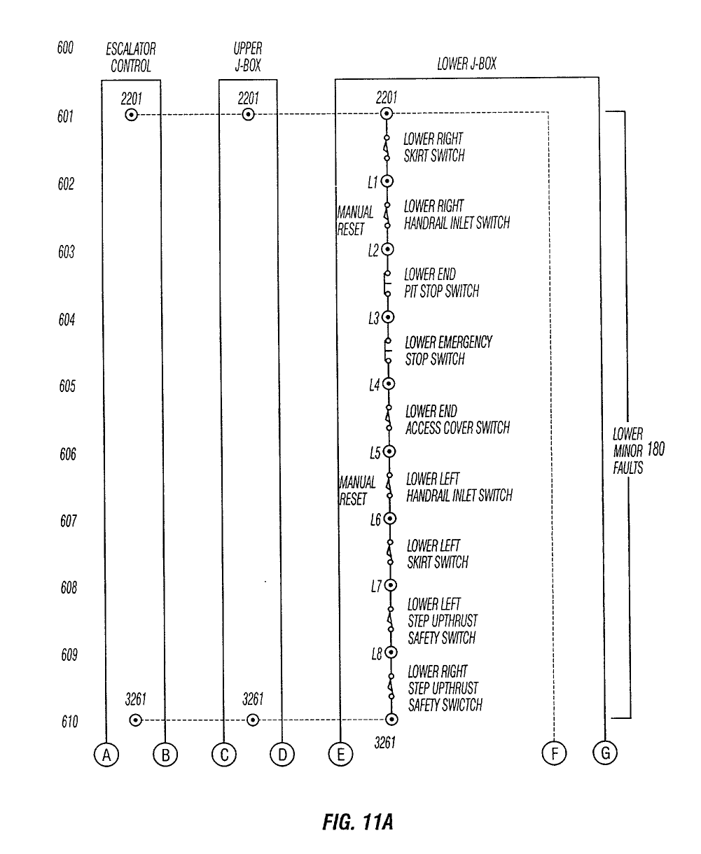

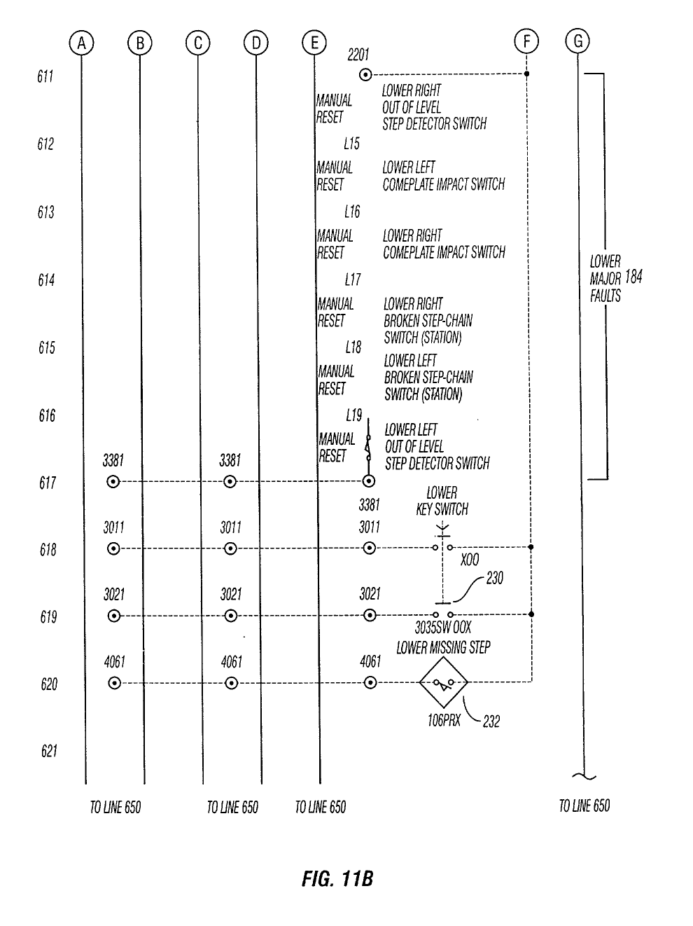

As seen in FIG. 11, common minor lower faults 180 include those faults triggered by problems relating to the lower right handrail, lower right skirt switch, lower access cover switch, lower left skirt switch, lower left handrail. Lower minor faults are also triggered by the engagement of the lower emergency stop switch and the lower motor pit stop switch.

Similarly, switches for lower major faults 184 are positioned in series, which maintain the contact that communicates 172 with the safety relay 162 for the lower major faults 184. These switches are for faults relating to the lower left combplate, lower right combplate, lower right out of level step detector, lower left out of level step detector and lower broken step/chain switches. All of the switches that relate to any major fault, including the minor faults for the handrail, must be manually reset for the system 10 to start or resume after this type of fault is detected. This is indicated in FIG. 9 by the manual reset notations near the relevant switches for those particular faults.

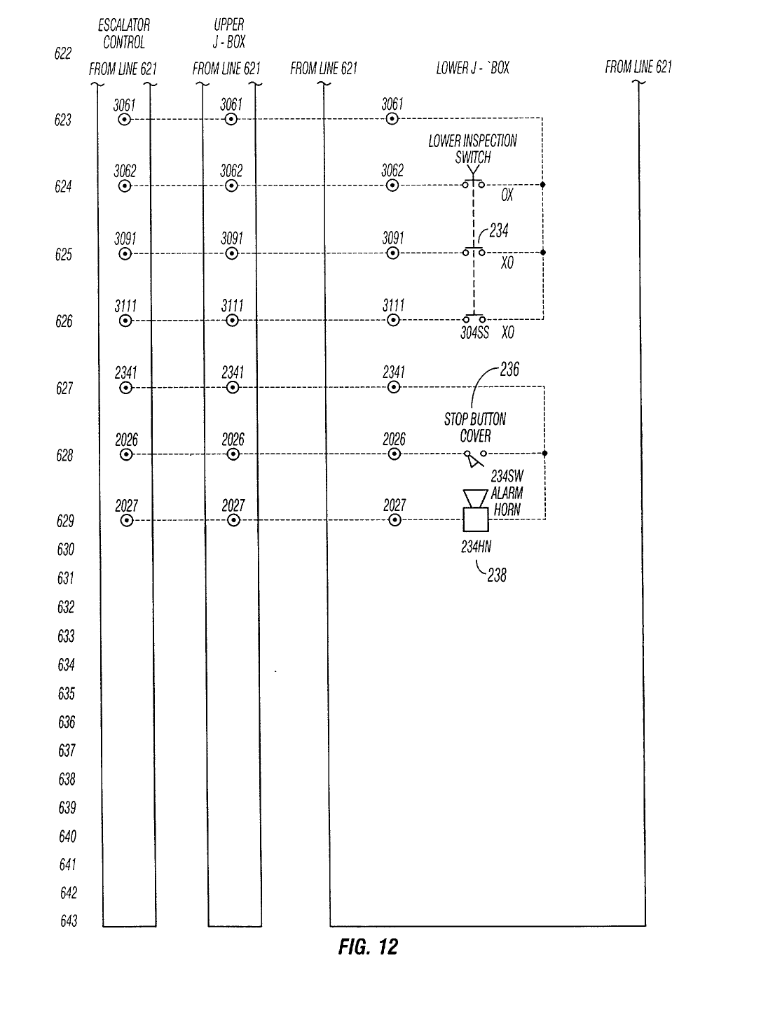

The lower fault box also communicates with the lower key switch 230 and the lower missing step proximity sensor 232, as shown in FIG. 11, and the lower inspection switch 234, lower stop cover button 236 and the horn 238, as shown in FIG. 12.

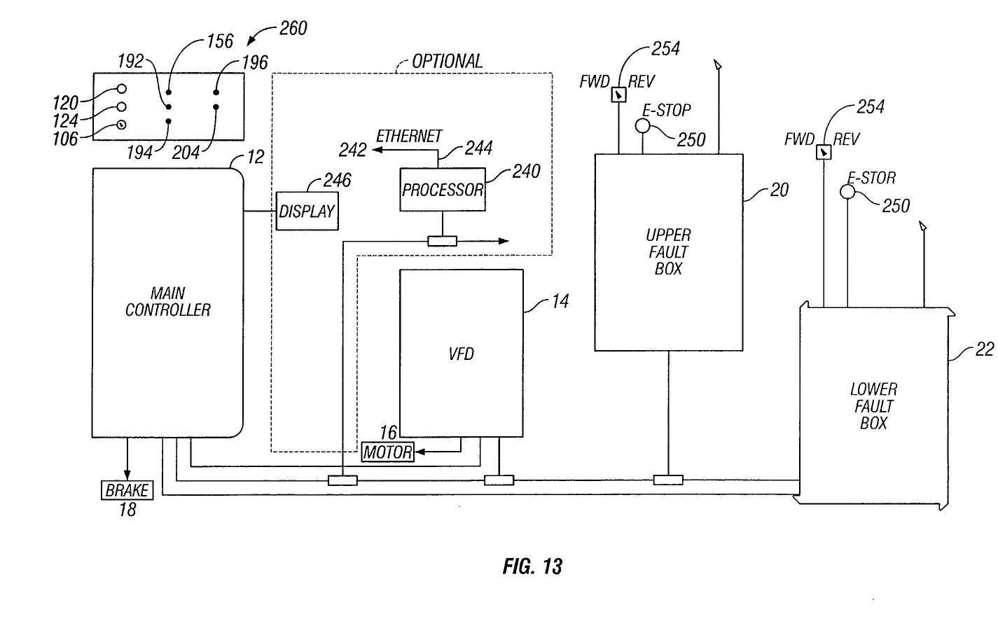

As illustrated by FIG. 13, although not necessary, the main controller 12 may also be designed to allow for installation of a microprocessor 240 that can be used to monitor the operation of the controller 12 along with monitoring external fault signals. If desired, the microprocessor 240 can be installed with an Internet or Ethernet connection 244 for central monitoring 242. The optional microprocessor 240 will also be installed with a monitor display 246 located on the top of the main controller box 12. The monitor 246 will allow the microprocessor 240 to display indicators for present and historical faults. The faults will be displayed in a manner to allow the user to identify a particular external fault, along with the time of fault. The display will be equipped with push buttons to allow resetting of fault history, along with manipulation of the indicators. The optional time and speed setting for energy savings may also be programmed through the display monitor.

In operation, the main disconnect switch is turned on. The emergency stop push buttons 120 (FIGS. 6 & 13) should be released and any fault reset buttons 124 (FIGS. 6 & 13) should be reset. Both the upper inspection switch (not shown) and lower inspection switches 234 should be in the run position. The ready lights should be on for the upper and lower minor fault switches 156, 192 and the upper and lower major fault switches 194, 196. Finally, the variable frequency drive light 204 should be on. When all these conditions have been met, the operator may then turn the spring return upper or lower switch 254 or the upper and lower switch on the control panel 106 to the up position when it is desired for the escalator to go up, or when it is desired for the escalator to go down, the spring return upper or lower switch 254, 106 should be turned to the down position.

During approximately the first fifteen seconds when the escalator is started and running, a timer holds in the over speed relay to give the system the opportunity to reach its optimal speed. Thereafter, the relay is held in by the over speed switches 86 and the missing step detector switches 134, 144.

When running, if a minor fault occurs, or if the upper or lower minor fault ready light is not on when the system is first powered, the system will stop if the system is running or will not start, in the case of the initial power-up. Typically, most minor faults do not require manual reset. Thus, once a minor fault is corrected, the system will resume running upon pressing the reset button 124.

If the system detects a major fault, the system will shut down, if running, or will not start when the system is initially powered. Only after the major fault is manually reset will the system resume or start.

To stop the escalator, an operator can depress the stop/fault reset pushbutton 124 on the control panel 260 of the main controller or can stop the escalator by pressing emergency stop push button 120 on the control panel 260 or at the emergency stop push buttons 250 at the top or bottom of the escalator near the handrails.

It will be understood that the above-described arrangements of apparatus and the method therefrom are merely illustrative of applications of the principles of this invention and many other embodiments and modifications, include different circuit configurations and positioning and use of different switches, relays, sensors and timers, may be made without departing from the spirit and scope of the invention as defined in the claims.

We claim:

1. A method for controlling an escalator through the use of common electro-mechanical devices, comprising:
a main controller in communication with a variable frequency drive and a brake, the variable frequency drive in communication with a motor;
a motion detection system, comprising at least one switch;
a fault detection system, comprising at least one switch in series with the at least one switch of the motion detection system;
the main controller having a start/stop relay circuit that communicates with the fault detecting system and motion detecting system and which is configured to prevent the escalator from moving in the event that the motion detecting system, the fault detecting or both the motion detecting system and the fault detecting system detect a fault in the operation of the escalator which the main controller controls.
